(19) United States
(12) Patent Application Publication
(10) Pub. No.: US 2016/0082367 A1
(43) Pub. Date: Mar. 24, 2016

(54) CONCENTRATION OF SUSPENSIONS

(71) Applicant: BASF SE, Ludwigshafen (DE)

(72) Inventors: Alexsandro BERGER, Sao Paulo (BR); Stephen ADKINS, West Yorkshire (GB)

(73) Assignee: BASF SE, Ludwigshafen (DE)

(21) Appl. No.: 14/787,119

(22) PCT Filed: Apr. 22, 2014
(86) PCT No.: PCT/EP2014/058140

§ 371 Date: Oct. 26, 2015

(30) Foreign Application Priority Data
Apr. 26, 2013 (EP) 13165652.2

(51) Int. Cl. B01D 21/24; B01D 21/28; C02F 1/72; C02F 1/56; C02F 1/70; B01D 21/01; C02F 1/36

(52) U.S. Cl. CPC B01D 21/2488; B01D 21/01; B01D 21/283; C02F 1/36; C02F 1/56; C02F 1/70; C02F 1/72; C02F 2001/007

(57) ABSTRACT

A process of concentrating an aqueous suspension of solid particles, comprising the steps of introducing the aqueous suspension of solid particles into a vessel, addition of at least one organic polymeric flocculant to the aqueous suspension of solid particles thereby forming flocculated solids, allowing the flocculated solids to settle to form a compression zone, comprising a bed of sedimented solids in suspension at the lower end of the vessel, flowing the sedimented solids from the vessel as an underflow stream, in which an effective amount of ultrasonic energy is applied to: a) the bed of solids at the compression zone; b) the sedimented solids in the underflow stream; or c) a recycle stream containing sedimented solids taken from either the underflow stream or the compression zone which are then recycled back to the vessel.

The present invention relates to an improved flocculation process for the concentration of suspensions. In particular flocculated solids can be settled to form a bed of solids in suspension which can be removed as an underflow.

It is known to concentrate suspensions of solids in aqueous liquids by use of flocculants resulting in flocculation of the solids which facilitates the separation of the solids from the liquid. In many processes the flocculated solids settle to form a bed by sedimentation. In other processes separation can be facilitated by mechanical dewatering, for instance in pressure filtration, centrifugation, by belt thickeners and belt presses.

The types of flocculant added to the suspension will often depend upon the substrate. Generally suspensions tend to be flocculated by high molecular weight polymers. Examples of this are described in WO-A-9314852 and U.S. Pat. No. 3,975,496 regarding the flocculation of mineral suspensions such as red mud. Other disclosures of high molecular weight polymeric flocculants include U.S. Pat. No. 6,447,687, WO-A-0216495 and WO-A-02083258 dealing with the flocculation of sewage sludge. It is known to add other chemical additives sometimes in order to condition the suspension. For instance suspensions may be first coagulated by a high charged density polymeric coagulant such as polyDADMAC or inorganic coagulants including ferric chloride.

Other additives are also use in conditioning of suspensions. For example peroxides are sometimes added to suspensions such as sewage sludges or other suspensions containing organic material in order to remove reducing agents in order to reduced odours, gas formation or prevent putrefaction. In general the peroxides or oxidising agents tend to be added in order to remove harmful or unwanted substances or other materials contained in the suspension. Generally the amount of peroxides added is only sufficient to remove the unwanted substances and materials and generally peroxides or other oxidising agents are included in relatively small amounts.

Examples of adding peroxides to sewage sludge are described in JP56150481. Peroxides or oxidising agents may also be added to other suspensions for similar reasons including treating dredged material to remove contaminants as described in US 2003 121863 and JP 10109100. JP 11156397 describes a process for flocculating mud using non-ionic and anionic polymers in which the mud has been pretreated with an oxidising agent.

U.S. Pat. No. 6,733,674 describes a method of dewatering sludge by adding an effective amount of one or more cellulolytic enzymes and one or more oxidants and one or more flocculants to form a mixture in water which is coagulated and flocculated followed by separation of solids from the water. The examples seem to indicate a significant time elapsed between oxidant addition and flocculation. The enzymes appeared to be present in order to degrade material contained in the sludge.

Suspensions are frequently concentrated in a gravity thickener vessel. A continual flow of the suspension is typically fed into the thickener and treated with a flocculant. The flocculated solids thus formed settle to form a bed of solid underflow and supernatant aqueous liquid flows upwards and is usually removed from the thickener vessel through a perimeter trough at the water surface. Normally the thickener vessel has a conical base such that the underflow can easily be removed from the centre of the base. In addition a rotating rake assists the removal of the underflow solids. A typical process for concentrating suspensions in a gravity thickener is described in U.S. Pat. No. 4,226,714.

Various suspensions can be concentrated in gravity thickeners, including suspensions of organic solids such as wastewater, sewage and sewage sludges. It is also commonplace to thicken or dewater mineral suspensions using gravity thickeners.

In a typical mineral processing operation, waste solids are separated from suspensions that contain mineral values in an aqueous process. The aqueous suspension of waste solids often contains clays and other minerals, and is usually referred to as tailings. These solids are often concentrated by a flocculation process in a thickener and settle to form a bed. Generally it is desirable to remove as much water from the solids or bed in order to give a higher density underflow and to recover a maximum of the process water or the aqueous medium that contains the valuable mineral dissolved therein. It is usual to pump the underflow to a surface holding area, often referred to as a tailings pit or dam, or alternatively the underflow may be mechanically dewatered further by, for example, vacuum filtration, pressure filtration or centrifugation. In some cases it may be desirable to pump the underflow to additional treatment steps in the mineral processing plant before disposal, for instance by pH regulation.

U.S. Pat. No. 5,685,900 describes a selective flocculation process for beneficiating a low brightness fine particle size kaolin in order to reduce a higher brightness kaolin clay. The process involves a classification step to recover the kaolin fraction wherein the particles are at least 90% by weight below 0.5 μm. The recovered fraction is then subjected to a bleaching step to partially bleach organic discolorants. The resulting slurry is selectively flocculated using a high molecular weight anionic polyacrylamide or acrylate acrylamide copolymer. This flocculation step forms a supernatant phase which is highly concentrated with contaminant titania and a flocculated clay phase which is devoid of titania that contains the discolorants. The flocs are then treated with gaseous ozone in order to oxidise the remaining discolouring organics and also destroy the flocculant polymer in order to restore the kaolin to a dispersed state. This is said to be achieved by passing the flocculated solids through an ozonation step, preferably using a high shear pump.

Similar disclosures are made in WO 2004071 989 and US 2006 0131243.

WO 2005 021129 discloses controlling the condition of a suspension of solid particles within a liquid including applying 1 or more stimuli to the suspension. In this disclosure conditioning is preferably reversible and involves flocculation and/or coagulation in which inter particle forces may be attractive or repulsive between the solid particles within the liquid. The stimulus may be one or more chemical additives and may for instance be a stimulus sensitive polyelectrolyte which can be absorbed on the surface of the suspended particles in sufficient quantity to create steric or electrostatic repulsion between the particles. In one instance a polyelectrolyte may be substantially insoluble at pH values where it is substantially uncharged thereby to effect flocculation of the suspension. Polyelectrolytes that are responsive to a temperature stimulus are also described. Reference is also given to a method of controlling the consolidation of a bed of solid particles within a liquid by applying one or more stimuli to the bed. Each stimulus effects reversibly operable conditioning between an initial state, prevailing prior to said conditioning, applying one or more stimuli and a conditioned state resultant from said one or more stimuli. The processes described bring about improvements in certain solids liquids separation activities.

JP 11-46541 describes a temperature sensitive hydrophilic polymer added to a suspension of particles below a transition temperature whereupon flocs are formed by absorbing and crosslinking particles as a conventional flocculant. The mixture is heated to above the transition temperature and the absorbed polymer becomes hydrophobic and the suspended particles are rendered hydrophobic and form flocs by hydrophobic interaction. Appropriate external pressure is applied at this time and the particles are readily realigned and water between the particles is expelled by the hydrophobicity of the particles.

JP 2001 232104 describes a process similar to JP 11-46541 but using improved temperature sensitive flocculants that are ionic temperature sensitive polymer as opposed to non-ionic polymers which a absorb onto suspended particles and when the polymer becomes hydrophobic at temperatures about the transition point there are strong hydrate layers around the ionic groups but hydrated layer adhesion between the polymers is prevented by hydrophobic interaction.

Bertini, V. et. al. Particulate Science and Technology (1991), 9(3-4), 191-9 describes the use of multifunctional polymers for the pH controlled flocculation of titanium minerals. The polymers are radical vinyl copolymers containing catechol functions and acrylic acid units. The polymers can change their effect from flocculating to dispersing or inert and vice versa by changing pH.

The pH or temperature sensitive flocculants in principle provide control over the flocculation state of a suspension. However, the choice of flocculant would need to be appropriate for the particular suspension or bed that is to be flocculated and at the same time be responsive to a particular stimulus to bring about the reversibly operable conditioning. In some cases it may be difficult to find the right choice of flocculant.

Frequently some water will be trapped in the flocculated solids and this water is often difficult to release and therefore held in the bed. Whilst pH and temperature responsive flocculants may assist with this problem it is often difficult to achieve satisfactory flocculation across a wide range of substrates.

In processes involving gravity thickeners it is desirable to operate such that the bed has the highest possible solids capable of being removed from the thickener as an underflow for maximising its operational capacity and therefore throughput. Normally the limiting factor is either the ability of the rake in the thickener to move the sedimented solids to the centre where usually the discharge point of the vessel is located or the ability of the pump to move the sedimented solids out of the vessel, due to the high torque at the rakes provided by the associated yield stress of the sedimented material or due to its high viscosity, respectively. It would therefore be desirable to provide a process which increases the rate of separation of the solids from the suspension and which assists the removal of the underflow.

WO 2011 146991 describes a gravity sedimentation process for the treatment of a slurry in a thickener to separate a solid from a liquid in which the thickener having, at steady state, a hindered settling zone and a compression zone. Ultrasonic energy is applied to the slurry in the hindered settling zone. The specification indicates that it is then possible to restructure aggregates and network range edge-edge chains that form in the hindered settling zone to release liquid and increase settling.

WO 2007 082797 describes a process of concentrating an aqueous suspension of solid particles by addition of organic polymeric flocculant to the suspension in order to form flocculated solids. The flocculated solids settle to become a more concentrated suspension. An agent selected from any of free radical agents, oxidising agents, enzymes and radiation is applied to the suspension prior to or substantially simultaneously with adding the organic polymeric flocculant and/or the organic polymeric flocculant and the agents are both added to the suspension in the same vessel. The process brings about a significant reduction in yield stress of the concentrated suspension or allows a significant increase in the solids content of the concentrated suspension for a given yield stress.

WO 2011/125047 achieves an improvement over the previous process by providing at least one of several means for introducing the agent. The means for introducing the agent includes one or more rakes which convey the agent; one or more conduits entering through the top of the vessel to which the agent is introduced; one or more apertures or conduits in the side walls of the vessel through which the agent is introduced; one or more apertures or conduits in the base of the vessel through which the agent is introduced; introducing the agent through one or more averages or conduits in the feed line conveying the bed of consolidated solids from the base of the vessel, preferably between the base of the vessel and a pump; and one or more sparges through which the agent is introduced.

International patent application PCT/EP2012/071009, unpublished at the date of filing of the present application, describes a process concentrating a suspension of solid particles in an aqueous medium by introducing at least one organic polymeric flocculant and an agent system. The agent system comprises i) at least one oxidising agent; and ii) at least one control agent. It is explained that the at least one control agent consists of iia) at least activator component and/or iib) at least one suppressor component, in which the at least one activator component increases the activity of the at least one oxidising agent and the suppressor component decreases the concentration or activity of the activator component. This process can provide more efficient use of the oxidising agent and therefore improved control of the concentrating of the suspension can be achieved.

European patent application 12178645.3, unpublished and the date of filing of the present application, describes a process of concentrating an aqueous suspension of solid particles addition of at least one organic polymeric flocculant to the aqueous suspension of solid particles to flocculate the solids. The flocculated solids settle for a bed of solids in the suspension at the lower end of the vessel and this bed of solids is removed from the vessel as an underflow. The improvement involves recycling a portion of the bed of solids or underflow as a recycle stream and then adding an active agent, selected from free radical agents, oxidising agent and reducing agents, to the solids in the recycle stream. Chemical agents are usually applied as dilute aqueous solutions. This form of addition allows convenient introduction of the chemical agents and the ability to easily control the dosing of the agent, for instance by the employment of pumps.

The inventors have discovered that the benefits of adding chemical agents are enhanced when they are added to the settled bed of solids or the underflow. However, the application of dilute solutions of into the settled bed of solids all the underflow tends to reduce the solids content. Further, in some situations it can often be inconvenient to introduce the solutions of agents directly into the bed or the underflow. In addition the introduction of such chemical agents requires delivering chemical agents to the site and in some cases additional steps for preparing the solutions agent at the correct concentrations as well as preparation and storage equipment.

Nevertheless, it would be desirable to achieve at least the same improvements increase solids content and/or reduced yield stress that only achieved with the aforementioned chemical agents without suffering the aforementioned disadvantages.

According to the present invention we provide a process of concentrating an aqueous suspension of solid particles, comprising the steps of,

introducing the aqueous suspension of solid particles into a vessel,

addition of at least one organic polymeric flocculant to the aqueous suspension of solid particles thereby forming flocculated solids,

allowing the flocculated solids to settle to form a compression zone, comprising a bed of sedimented solids in suspension at the lower end of the vessel,

flowing the sedimented solids from the vessel as an underflow stream,

in which an effective amount of ultrasonic energy is applied to:
a) the bed of solids at the compression zone;
b) the sedimented solids in the underflow stream; or
c) a recycle stream containing sedimented solids taken from either the underflow stream or the compression zone which are then recycled back to the vessel.

The present invention also concerns an apparatus suitable for concentrating an aqueous suspension of solid particles comprising

a vessel,

a means for introducing the aqueous suspension of solid particles into the vessel,

a means for introducing at least one organic polymeric flocculant to the aqueous suspension of solid particles, sufficient to form flocculated solids,

a means for allowing the flocculated solids to form a compression zone, comprising a bed of sedimented solids in suspension at the lower end of the vessel,

a means for flowing the sedimented solids from the vessel as an underflow stream, in which the apparatus comprises a means for applying ultrasonic energy to:
a) the bed of solids at the compression zone;
b) the sedimented solids in the underflow stream; or
c) a recycle stream containing sedimented solids taken from either the underflow stream or the compression zone which are then recycled back to the vessel.

The inventors have found that the specific application of the ultrasonic energy to the bed of solids at the compression zone; the sedimented solids in the underflow stream; or the recycle stream containing sedimented solids unexpectedly brings about a remarkable improvement in terms of either increased solids content for a given yield stress or reduced yield stress for a given solids content, without the addition of chemical agents.

Without being limited to theory, the inventors believe that the ultrasonic irradiation of the aqueous media, produces in situ active agents, including oxidising agents and free radicals and also hydrogen peroxide. This can be referred to as sonochemistry. This is especially the case by the utilisation of low-frequency and high intensity ultrasound. The inventors believe that this effect of ultrasonic energy arises from the so-called phenomenon of cavitation, which can take place due to the propagation of ultrasonic waves through a liquid, especially water-based. This phenomenon may comprise the production of microbubbles that in turn lead to a local transient high temperature, pressure and electrical discharge. The inventors believe that the water molecules may be cleaved and produce free radicals such as H., HO. and .O₂. The hydroxyl radicals (HO.) are the major radicals that are believed to be formed and they can combine with each other to produce hydrogen peroxide.

Without being limited to theory, the inventors believe that, concomitantly with the aforementioned chemical effect, the ultrasonic energy produces a strong hydrodynamic shear force that also assists to a breakdown of the large sized flocs presented in the sedimented material into small aggregates.

The inventors discovered that the aforementioned improved effect on solids content and yield stress is unexpectedly achieved despite the very high solids content throughout the suspension that is treated.

The process of the present invention is typically a gravity sedimentation process. Usually the process is directed to dewatering processes and thickening processes and the like. In the process the flocculated solids are allowed to settle to form a bed of solids. The bed of solids is regarded as the compression zone. Typically in the bed of solids or compression zone the solids are more consolidated and are regarded as sedimented.

Location of the settled bed, i.e. the compression zone, in the vessel may be achieved by conventional means. Different techniques can be employed to determine the level of the bed of solids as the compression zone in the vessel below which the settled bed of solids would be located. Typical methods include determining the theoretical settled bed level based on the calculation of the average density of a constant height using a hydrostatic pressure sensor, the use of a turbidity sensor, either at a fixed height or attached to a motorised cable spool, or the use of a buoyancy-based electromechanical. To overcome interference from the use of rakes in thickeners, device measurement cycles can be automated so that measurement takes place between rake rotations.

Suitably the present invention can be operated by addition of ultrasonic energy anywhere within the settled bed of solids within the vessel i.e. the ultrasonic energy should be applied anywhere below the settled bed level. It may be desirable to additionally apply the ultrasonic energy elsewhere in the vessel, for instance into the region where the solids are settling, for instance the free settling zone or the hindered settling zone. Nevertheless, it is preferable that the ultrasonic energy is applied only to one or more of the bed of solids at the compression zone within the vessel; the sedimented solids in the underflow stream; or a recycle stream containing sedimented solids taken from the underflow stream and recycled back to the vessel.

The amount of ultrasonic energy applied is generally regarded as being effective in inducing a decrease in yield stress for a given solids content or alternatively inducing an increase in solids for a given yield stress. The actual amount of ultrasonic energy to be applied may be determined on a thickener by thickener basis and should be generally determined by the particular solids in the suspension or on various operating conditions.

The degree of improvement of the increased solids content for a given yield stress and/or reduction in yield stress for a given solids content can depend on the amount of the cavitation phenomena produced in the medium, in which free radicals formed, and also the hydrodynamic shear force. This may depend on various factors as the amplitude of the ultrasonic irradiation (sonication), measured in microns, and the specific energy provided to the suspension. Specific energy means the power delivered at the surroundings of the ultrasonic probe (sonotrode) at a given time per a given volume of suspension (medium), usually measured in W·sec/mL.

The degree of improvement of the rheological properties of the consolidated material, in terms of either increased solids content for a given yield stress or reduced yield stress for a given solids content, can depend on the amount of the cavitation phenomena, where free radicals form, that can occur and also the hydrodynamic shear force produced. This in turn is thought to depend on the amplitude (measured in microns) and the specific energy (measured in W·seconds/millilitres) of the ultrasonic energy provided in any given medium. W is Watts and is the measure of power and the specific energy is the power applied at a given time per volume of medium.

The amplitude of the ultrasonic energy may be as low as 0.01 μm. Generally though the amplitude should be at least 1 μm. The amplitude may be significantly higher than this although it is not normally necessary for it to be greater than 100 μm. Usually the amplitude should be within the range of 1-50 μm.

The specific energy may be typically in the range of 0.1 to 1000 W·seconds/millilitres, preferably between 1 and 100 W·seconds/millilitres, more preferably 2 to 50 W·seconds/millilitres.

Suitably the frequency of the ultrasonic energy applied to the bed of solids, the underflow or the recycle stream should be in the range of 1 KHz to 10 MHz. Preferably the range should be between 5 KHz to 1 MHz (called low frequency ultrasound), more preferably between 10 KHz to 100 KHz.

When the ultrasonic energy is applied to the settled bed in the vessel it should be applied anywhere below the settled bed level. Suitably the ultrasonic energy may be applied to the settled bed by fixing ultrasonic transducers around the inside or outside of the vessel wall at the height corresponding to the bed of sedimented solids (compression zone). Alternatively, ultrasonic transducers may be affixed to the rakes at the height of the bed of solids. Desirably the transducers should be connected to a control unit which can adjust the power output of the transducer to a desired power density.

Preferably the process employs an immersible transducer within the vessel in order to increase the efficiency of delivering the ultrasonic energy to the bed of sedimented solids. In some cases, however, it may be desirable if the transducer is affixed outside the vessel.

When the ultrasonic energy is applied to the sedimented solids in the compression zone, the underflow stream or a recycle stream containing sedimented solids and recycled back to the vessel, the ultrasonic transducers may be fixed inside or outside a conduit which conveys the respective underflow stream or recycle stream. It may be desirable to apply the ultrasonic energy prior to a pumping stage. It may also be desirable to apply the ultrasonic energy in several stages along the respective conduit.

By applying the ultrasonic energy into the recycle stream the mixture of solids in suspension the in situ generated active agent, for instance oxidising agents, free radicals and hydrogen peroxide, would tend to distribute throughout the consolidating flocculated slurry of solids in the vessel.

Suitably the recycle stream may be taken from the bed of solids in suspension. It may be taken from anywhere within the compression zone comprising the bed of sedimented solids, but preferably from the part of the bed where further consolidation has taken place. Typically, this may be in the lower 60% of the bed and generally in the lower half of the bed. It may also be desirable to take the recycle stream from the bed just above the outlet of the vessel, for instance no higher than 2 m above the lowest point of the vessel, no higher than 1 m above the lowest point of vessel or no higher than 50 cm above the lowest point of the vessel.

In one embodiment the recycle stream may be taken from a conduit conveying the underflow as an underflow stream (underflow conduit) from the vessel, for instance before or after the underflow pump. Typically the underflow conduit may be a pipe or other channel flow line, such as a channel. The underflow conduit may have a pump to help with the transfer of the underflow. It may be desirable to take the recycle stream from the underflow conduit before the underflow reaches the pump, i.e. between the pump and the outlet of the vessel. It may alternatively be desirable to take the recycle stream from the underflow conduit after the pump. This may be at any stage after the pump but generally within the vicinity of the pump. For example the recycle stream may be taken from the underflow conduit within 5 m of the pump, usually within 3 m of the pump and often within 2 m of the pump.

The recycle stream should generally be in a suitable conduit, such as a pipeline. The solids in suspension extracted from either the bed or underflow may require some means of propulsion, for instance a pump.

In the process of the present invention although sufficient effect on the solids content and yield stress can be achieved by the addition of ultrasonic energy in the absence of adding a chemical agent, the effect is further enhanced by using the ultrasonic energy in conjunction with the addition of a chemical agent, selected from oxidising agent, free radical agents and reducing agents. The chemical agent may be added suspension at any stage, for instance before entering the vessel or anywhere in the vessel, such as to the solids before they are flocculated, the flocculated solids or settling solids. Preferably the chemical agent should be added to the bed of solids, the underflow or a stream taken from the bed of solids or the underflow and recycled back into the vessel.

The application of ultrasonic energy together with the aforementioned chemical agent brings about a further enhancement of the process.

The exact mechanism by which the combination of ultrasonic energy and the aforementioned chemical agent acts on the bed of consolidated solids is not entirely understood. However, the inventors believe that the action of the ultrasonic energy on the settled bed, underflow or the aforementioned recycle stream creates chemical agents, such as oxidising agents, free radical agents and reducing agents. It is further believed that introduction of added chemical agent, selected from oxidising agents, free radical agents and reducing agents into the settled bed, underflow or aforementioned recycle stream boosts the effect of the chemical agents generated by the ultrasonic energy.

In the invention it would appear that the chemical interaction between the flocculant and the solids may be permanently altered as a result of the action of the ultrasonic energy or the combination of ultrasonic energy and aforementioned chemical agent. It would also appear that the flocculated structure may be diminished or collapsed to such an extent that the solids occupy a smaller volume. We also find that this is a more concentrated aqueous suspension which is formed by the action of the active agent may have improved flow characteristics. It is apparent that the yield stress of this more concentrated aqueous suspension may be significantly reduced for a given solids content. Furthermore, it is possible to increase the solids content for any given yield stress value.

In one preferred form the action of ultrasonic energy or a combination of ultrasonic energy and aforementioned chemical agent to the settled bed of solids, underflow or aforementioned recycle stream brings about a reduction in the yield stress of a layer or bed of solids suspension formed from the action of the organic flocculant. More preferably the layer or bed of solids should be at least 5%, often at least 10%, desirably at least 20% and suitably at least 30% below the yield stress of a layer of solids at an equivalent solids content without the addition of the active agent. Thus the action of applying ultrasonic energy or combination of applying ultrasonic energy with the addition of aforementioned chemical agent desirably brings about a reduction in the yield stress of the layer or bed of consolidated solids it enables higher solids to be achieved and an increased removal of the underflow. Preferably the reduction in yield stress will be at least 50% below the yield stress of a layer of solids at an equivalent solids content without the addition of the agent. More preferably the reduction in yield stress will be at least 60 or 70% and often at the least 80 or 90%.

We have also found that the yield stress can be reduced below the yield stress of a layer or bed of solids in suspension at an equivalent solids content that had not been flocculated and without the addition of the ultrasonic energy or combination ultrasonic energy and the chemical agent. Previously there had been a generally accepted view that sedimentation of solids in the absence of flocculation would achieve the lowest yield stress. It had been generally believed that a process involving flocculation would always result in a higher yield stress than in the absence of the flocculant because the flocculant would tend to hold the sedimented solids in a structure that would tend to increase the yield stress. The process of the present invention is particularly effective at achieving this benefit.

In the process the flocculated solids settle to form a bed of solids and water is released from the suspension and in which we have found that the introduction of the ultrasonic energy or combination of ultrasonic energy and aforementioned chemical agent active agent into the bed of solids in suspension by the means according to the present invention brings about an increase in the water released from the suspension. Consequently, we find that this increase in water released is also accompanied by an increase in the solids.

The process of the present invention has been found to enhance the concentration of a suspension, by gravity sedimentation. In this sense the rate of consolidation of separated solids is increased. In addition the mobility of concentrated phase, i.e. settled or sedimented solids, can be significantly improved.

The added chemical agent according to the preferred aspect of the invention is selected from the group consisting of oxidising agents, reducing agents and free radical producing agents.

Suitably the oxidising agent may be selected from perchlorates, hypochlorites, perbromates, hypobromites, periodates, hypoiodites, perborates, percarbonates, persulphates, peracetates, ozone and peroxides. The use of peroxides, ozone, hypochlorites, peracetates, perborates, percarbonate and persulphates have been found to be particularly effective for oxidizing purposes.

Preferred oxidising agents for use in present invention are peroxides and ozone. A particular preferred peroxide is hydrogen peroxide. Suitably the hydrogen peroxide will be in an aqueous solution containing at least 1% hydrogen peroxide on weight basis, typically at least 5% and often at least 10% and often at least 20%, preferably at least 30% as much as 50 or 60% or more. When ozone is used it may be used as a gas by direct injection of the gas although it is preferred that the ozone is in the form of ozone water. Typically the ozone water would have a concentration of at least 0.1 ppm and usually at least 1 ppm. The concentration of ozone in the ozone water may be as much as 1000 ppm or more (on the basis of weight of ozone per volume of water) but usually effective results are obtained at lower concentrations, such as up to 500 ppm or even up to 100 ppm. The ability to achieve a particular concentration of ozone in water will often depend upon the equipment used to combine the ozone with the water, the temperature of the water and ozone and the pressure. High concentrations may sometimes be achievable in highly pressurised systems especially at lower temperatures. Often the concentration will be in the range of between 5 ppm and 50 ppm, for instance between 10 ppm and 40 ppm, especially between 20 ppm and 30 ppm.

It has been found that application of ozone gas directly into the recycle stream is also more achievable and more effective than injecting ozone gas directly into the suspension in a vessel.

The amount of at least one oxidising agent will vary according to the specific process conditions, the type of substrate and flocculant. The oxidising agent preferably should be introduced at a dose in an amount of at least 1 ppm based on weight of agent on volume of the aqueous suspension. The oxidising agent can be effective at low levels for example between 1 and 10 ppm. Generally the oxidising agent will be added in an amount of from at least 100 ppm and in some cases may be at least 1000 ppm based on weight of oxidising agent on the volume of the aqueous suspension of solid particles. In some cases it may be desirable to add significantly higher levels of the oxidising agent, for instance as much as 40,000 or 50,000 ppm or higher. Effective doses usually will be in the range between 150 and 20,000 ppm, especially between 500 and 5,000 ppm.

When the chemical agent is a reducing agent it may for instance be sulphites, bisulphites, phosphites, hypophosphites and phosphorous acid etc. These may be provided as the ammonium or alkali metal salts such as sodium or potassium salts.

By addition of free radical agents we mean the inclusion of anything which form or generate free radicals in situ. Suitable free radical agents include chemical compounds selected from the group consisting of ferrous ammonium sulphate, ceric ammonium nitrate etc. Furthermore, any of the compounds listed as either oxidising agents or reducing agents may also be regarded as free radical agents.

The amount of at least one reducing agent or at least one free radical agent desirably may be in the same ranges as that of the oxidising agent mentioned above.

Preferably, the chemical agent used in combination with the ultrasonic energy is an oxidising agent. More preferably it is either ozone or peroxide.

It may also be desirable to employ the application of ultrasonic energy in accordance with the present invention in conjunction with a suitable control agent. Desirably the control agent may be at least one activator component and/or at least one suppressor component. The at least one activator component increases the activity of the at least one oxidising agent and the suppressor component decreases the concentration or activity of the activator component.

It may be desirable to additionally employ the ultrasonic energy or combination of ultrasonic energy with at least one active agent as part of an agent system as described in WO-A2013/060700. In this case agent system comprises i) at least one oxidising agent as the at least one active agent; and ii) at least one control agent. The at least one control agent should consist of iia) at least one activator component and/or iib) at least one suppressor component, in which the at least one activator component increases the activity of the oxidising agent and the suppressor component decreases the concentration or the activity of the activator component.

The agent system may involve

1) the at least one activator component being added to the suspension before the flocculated solid particles have settled and the at least one oxidising agent added into the recycle stream; or

2) the at least one activator component being added to the recycle stream and the at least one oxidising agent added into the recycle stream; or

3) the at least one suppressor component being added to the suspension before the flocculated solid particles are several and the at least one oxidising agent is added into the recycle stream; or

4) the at least one suppressor component being added to the recycle stream and the at least one oxidising agent being added into the recycle stream; or

5) the at least one activator component is present in suspension at a concentration (C2) which will not increase the activity of the oxidising agent and which concentration (C2) is above the effective concentration or range of concentrations (C1) that would increase the activity of the oxidising agent; and the at least one suppressor component is added to the suspension before the flocculated solid particles have settled at a dose sufficient to reduce the concentration of the activator component to the effective concentration or within the range of concentrations (C1); and the at least one oxidising agent is added to the recycle stream; or

6) the at least one activator component is present in suspension at a concentration (C2) which will not increase the activity of the oxidising agent and which concentration (C2) is above the effective concentration or range of concentrations (C1) that would increase the activity of the oxidising agent; and the at least one suppressor component is added to the recycle stream at a dose sufficient to reduce the concentration of the activator component to the effective concentration or within the range of concentrations (C1); and the at least one oxidising agent is added to the recycle stream.

When the control agent comprises at least one activator component, the activator component may be any entity which increases the activity of the oxidising agent. The activator component within the scope of the present invention also includes materials which are either precursors to or can be converted into materials which increase the activity of the oxidising agent. Typically the activator component may interact with the oxidising agent to form oxidising radicals. Suitably the formation of these oxidising radicals will be at a faster rate and/or provide an increased concentration of oxidising radicals than the oxidising agent would have formed had the activator component not been added.

Typical doses of activator component may range from 0.1 ppm based on weight of activator on volume of aqueous suspension of solids. Preferably the activator component should be introduced at a dose in an amount of at least 1 ppm or at least 10 ppm. The activator component can be effective at low levels for example between 1 and 10 ppm. Alternatively, the activator component suitably can be effective at levels for example between 10 and 100 ppm. In other cases the activator component can be added in an amount of from at least 100 ppm and in some cases may be at least 1000 ppm based on the volume of the aqueous suspension. In some cases it may be desirable to add significantly higher levels of the activator component, for instance as much as 40,000 or 50,000 ppm or higher. Effective doses usually will be in the range between 150 and 20,000 ppm, especially between 500 and 5000 ppm.

Preferably the activator component of the at least one control agent is selected from the group consisting of iron (II) ions (Fe2+) (ferrous ions), iron (III) ions (Fe3+) (ferric ions), iron (IV) ions (Fe4+) (ferryl ions) and copper (II) ions (Cu2+) (cupric ions). Typically the iron (II), iron (III), iron (IV) or copper (II) ions may be employed in the form of suitable salts of the respective ions. Such salts may for instance be iron (II) sulphate, iron (II) nitrate, iron (II) phosphate, iron (II) chloride, iron (III) sulphate, iron (III) nitrate, iron (III) phosphate, iron (III) chloride, iron (IV) sulphate, iron (IV) nitrate, iron (IV) phosphate, iron (IV) chloride, copper (II) sulphate, copper (II) nitrate, copper (II) phosphate, copper (II) chloride. The respective ions tend to interact with the oxidising agent to more rapidly generate suitable reactive radicals thereby accelerating the effect of the oxidising agent. For instance iron (II) ions and copper (II) ions tend to interact with peroxides to promote the rapid formation of the hydroperoxyl radical (.OOH) and hydroxyl radical (.OH) which is an extremely powerful oxidising agent.

When the oxidising agent is hydrogen peroxide and the control agent comprises one of the metal ions consisting of iron (II) ions (Fe2+) (ferrous ions), iron (III) ions (Fe3+) (ferric ions), iron (IV) ions (Fe4+) (ferryl ions) or copper (II) ions (Cu2+) (cupric ions), both in combination with the ultrasonic irradiation, a so-called Sono-Fenton Chemistry, in this scenario the formation of free radicals such as hydroxyl peroxide (.OH) and subsequently hydrogen peroxide is enhanced.

It may be desirable to use a combination of different activator components all one or a combination of compounds which liberate suitable activator components. For instance a compound in a high oxidation state may be used in combination with copper (I) containing compounds to generate copper (II) compounds. For instance, ferric chloride may be used in combination with copper (I) chloride thereby generating ferrous chloride and cupric chloride. Such compounds which may be precursors to activator components or which may be converted into activator components are also to be regarded as activator components within the meaning of the present invention.

When the at least one control agent comprises at least one suppressor component, the suppressor component may be any material or other entity which reduces the concentration or activity of the at least one activator component. Suitably the suppressor component may include material selected from at least one of the group consisting of:
a) radical quencher,
b) sequestering agent; and
c) metal salts that promote the formation of side and deactivated (complexes) species.

Radical quenchers tend to be chemical compounds which remove radicals from the environment in which they exist. Suitably the radical quenchers include compounds, such as sodium bisulphite. Radical quenchers tend to reduce the effect of the activator component, for instance by capturing the oxidising agent, for example as free radicals.

Sequestering agents may include any compound which is capable of chelating or sequestering the activated components, for instance metal ions. Suitable sequestering agents include EDTA (ethylenediamine tetra acetic acid or salts thereof, for instance the tetra sodium salt); ethylenediamine; DTPA (diethylene triamine pentaacetic acid or salts thereof, for instance the penta sodium salt); HEDPA (hydroxyethylidene diphosphonic acids or salts thereof, for instance the tetra sodium salt); NIL (nitrilotriacetic acid or salts thereof, for instance the tri sodium salt); ATMP (amino trimethylene phosphonic acid or salts thereof, for instance the hexa sodium salt); EDTMPA (ethylene diamine tetra methylene phosphonic acid or salts thereof, for instance the octa sodium salt); DTPMPA (diethylene triamine penta methylene phosphonic acid or salts thereof, for instance the deca sodium salt); PBTCA (2-phosphonobutane-1,2,4-tricarboxylic acid or salts thereof, for instance the penta sodium salt); polyhydric alcohol phosphate ester; 2-hydroxy phosphono carboxylic acid or salts thereof, for instance the di sodium salt; and BHMTPMPA (Bis(hexamethylene triamine penta(methylene phosphonic acid)) or salts thereof, for instance the deca sodium salt).

It is known that in general solids in suspensions will often settle without the addition of flocculant. The flocculant brings about bridging flocculation of the solids and increases the rate at which the solids settle to form a bed. Thus in conventional gravity thickening situations, improved rate of free settlement and initial compaction are achieved by the use of polymeric flocculants and optionally coagulants. In such a process the individual solid particles tend to gather together to form aggregates which have a more favorable density to surface area ratio. These aggregates can settle to form a compacted bed from which water can be further removed by upward percolation. In this way the bed progressively increases in solids content over an extensive period of time until the desired solids concentration in the bed is reached and material in the bed can be removed.

Unfortunately, in general the yield stress of the flocculated settled solids in conventional processes tends to be significantly higher than the settled solids in the absence of the flocculant. This tends to make the removal process of raking and pumping progressively more difficult. On the other hand it would not be practical to concentrate a suspension in the absence of flocculant since this would take an extremely long time, especially in a gravimetric thickener which relies upon free sedimentation.

In the process according to the invention we have found that a more rapid compaction phase can be achieved. In addition it has been found that the present process tends to result in a significantly reduced viscosity or yield stress of the layer of solids or bed as a result of treatment by the ultrasonic energy or ultrasonic energy in combination with the aforementioned chemical agent or aforementioned agent system. In particular we find that the yield stress is not only lower than the equivalent process in the absence of the agent, but the yield stress can be as low as or lower than settled solids in the absence of the flocculant. In some cases we find that the process results in a layer or bed of solids having a yield stress significantly below that of settled solids in the absence of flocculant. This unexpected property of the settled solids facilitates the ease of removal of a solids underflow whilst at the same time ensuring rapid settling of the solids. Furthermore, it is preferred that the process is operated by allowing the solids content of the consolidated bed to increase significantly above that which can be tolerated by the equipment in the absence of the agent. In this sense the consolidated bed may still be operated at the maximum yield stress for the equipment but in which the solids content is significantly higher than the bed in a process without the active agent.

The yield stress of the layer of solids including sedimented bed will vary according to the substrate. Typically the maximum yield stress of a sedimented bed that can be tolerated by conventional equipment is usually no more than 250 Pa. Within capabilities of the existing equipment it would not be possible to increase the solids using the conventional process since the yield stress would be too high. The process of the invention employing the active agent has been found to reduce the yield stress by at least 10% and usually at least 50% and in some cases as much as 80 or 90% or higher. On the other hand the solids content of the layer or bed produced according to the invention can be allowed to increase by at least 1%, at least 2% or at least 5% (percentage increase means relative percentage increase unless indicated otherwise) and sometimes more than 10% without exceeding the maximum yield stress that can be tolerated by the equipment. In some cases it may be possible to increase the solids by up to 15 or 20% or more in comparison to a layer or bed having the same yield stress obtaining by the equivalent process but in the absence of the active agent.

The actual weight percent underflow solids that can be achieved with acceptable yield stress varies considerably dependent upon the constituent and particle size of the suspended solids, and also the age and sophistication of the settling equipment. It may be as low as around 12% (typically Florida phosphate slimes) but is usually between around 20% and 50%.

The Yield Stress is measured by Brookfield R/S SST Rheometer at an ambient laboratory temperature of 25° C. using the RHEO V2.7 software program in a Controlled Shear Rate mode. Rotation of a Vane spindle (50_{—}25 vane at a 3 to 1 vessel sizing) in 120 equal step increases of 0.025 rpm generate a progressive application of increased Shear Rate.

Yield Stress is defined as the maximum shear stress before the onset of shear.

The Yield Stress is calculated by linear regression of the 4 measurement points with Shear Rate>0.1 1/s and subsequent calculation of the intercept of the axis of Tau (Pa) for Shear Rate=0.

The invention is applicable to any solids liquid separation activity in which solids are separated from a suspension by gravity sedimentation in a vessel. Particularly preferred processes involve subjecting the suspension to flocculation in a gravimetric thickener. In such a process the solids form a compacted layer of concentrated solids, which in general will be significantly higher than in the absence of the active agent.

The bed of solids resulting from the process may form an underflow which would normally be removed from the vessel. In many instances the bed of solids forms an underflow which is then transferred to a disposal area. Alternatively the underflow may be transferred to a further processing stage, such as filtration. The further processing stage would typically be a further mineral processing stage, such as filtration, further extraction of mineral values or pH regulation prior to discharge to taillings dam.

As indicated previously the invention is applicable generally to solids liquid separation processes which involve gravity sedimentation in a vessel. Thus the suspension may comprise organic material including for instance sewage sludge or cellular material from fermentation processes. The suspension may also be a suspension of cellulosic material, for instance sludges from papermaking processes. Preferably the suspension is an aqueous suspension comprising mineral particles.

The aqueous suspension of particles comprises red mud or tailings from metal extraction, coal, oil sands, mineral sands or other mining or mineral processing operations

In a more preferred aspect of the invention the process involves the treatment of aqueous suspensions resulting from mined mineral processing (eg. acid leaching) and other mining wastes, for instance from carbon based industries such as coal and tar sands, comprising suspensions of mineral particles, especially clays. Thus in this preferred aspect of the process the aqueous suspension is derived from mineral or energy processing operations and/or tailings substrates. By energy processing operations we mean preferably processes in which the substrate involves the separation of materials useful as fuels.

A particularly preferred aspect of the process involves suspensions selected from mining and refining operations the group consisting of bauxite, base metals, precious metals, iron, nickel, coal, mineral sands, oil sands, china clay, diamonds and uranium.

Preferably suspended solids in the suspension should be at least 90% by weight greater than 0.5 microns. Frequently the particles in suspension will be at least 90% by weight at least 0.75 microns and preferably at least 90% by weight at least one or two microns. Typically suspended particles may have a particle size at least 90% by weight up to 2 mm and usually at least 90% by weight within the range above 0.5 microns to 2 mm. Preferably suspended particles will be at least 90% by weight up to 1 mm or more preferably at least 90% by weight up to 750 microns, especially at least 90% by weight within the range of between one or two microns and one or two millimeters.

The suspensions will often contain at least 5% by weight suspended solids particles and may contain as much as 30% or higher. Preferably suspensions will contain at least 0.25% more preferably at least 0.5%. Usually the suspensions will contain between 1% and 20% by weight suspended solids.

Suitable doses of organic polymeric flocculant range from 5 grams to 10,000 grams per tonne of material solids. Generally the appropriate dose can vary according to the particular material and material solids content. Preferred doses are in the range 10 to 3,000 grams per tonne, especially between 10 and 1000 grams per tonne, while more preferred doses are in the range of from 60 to 200 or 400 grams per tonne.

The aqueous polymer solution may be added in any suitable concentration. It may be desirable to employ a relatively concentrated solution, for instance up to 10% or more based on weight of polymer. Usually though it will be desirable to add the polymer solution at a lower concentration to minimise problems resulting from the high viscosity of the polymer solution and to facilitate distribution of the polymer throughout the suspension. The polymer solution can be added at a relatively dilute concentration, for instance as low as 0.01% by weight of polymer. Typically the polymer solution will normally be used at a concentration between 0.05 and 5% by weight of polymer. Preferably the polymer concentration will be the range 0.1% to 2 or 3%. More preferably the concentration will range from 0.25% to about 1 or 1.5%. Alternatively the organic polymeric flocculant may be added to the suspension in the form of dry particles or instead as a reverse phase emulsion or dispersion. The dry polymer particles would dissolve in the aqueous suspension and the reverse phase emulsion or dispersion should invert directly into the aqueous suspension into which the polymer would then dissolve.

The process according to the invention exhibits improved sedimentation rates. It has been found that sedimentation rate is between 2 and 30 m/hour can be achieved. In addition we find that the process enables greater than 99% by weight of the suspended solids to be removed from a suspension. In addition the process enables an increase in solids sediment concentrations of greater than 10% by weight in comparison to conventional processes operating in the absence of the agent. More preferably reduced sediment yield stress is obtaining compared to the best conventional processes.

The organic polymeric flocculant may include high molecular weight polymers that are cationic, non-ionic, anionic or amphoteric. Typically if the polymer is synthetic it should exhibit an intrinsic viscosity of at least 4 dl/g. Preferably though, the polymer will have significantly higher intrinsic viscosity. For instance the intrinsic viscosity may be as high as 25 or 30 dl/g or higher. Typically the intrinsic viscosity will be at least 7 and usually at least 10 or 12 dl/g and could be as high as 18 or 20 dl/g.

Intrinsic viscosity of polymers may be determined by preparing an aqueous solution of the polymer (0.5-1% w/w) based on the active content of the polymer. 2 g of this 0.5-1% polymer solution is diluted to 100 ml in a volumetric flask with 50 ml of 2M sodium chloride solution that is buffered to pH 7.0 (using 1.56 g sodium dihydrogen phosphate and 32.26 g disodium hydrogen phosphate per litre of deionised water) and the whole is diluted to the 100 ml mark with deionised water. The intrinsic viscosity of the polymers are measured using a Number 1 suspended level viscometer at 25° C. in 1M buffered salt solution.

Alternatively, the organic polymeric flocculant may be a natural polymer or semi natural polymer. Typical natural or semi natural polymers include polysaccharides. This will include cationic starch, anionic starch, amphoteric starch, chitosan.

One preferred class of polymers includes for instance polysaccharides such as starch, guar gum or dextran, or a semi-natural polymer such as carboxymethyl cellulose or hydroxyethyl cellulose.

One preferred class of synthetic polymers includes polyethers such as polyalkylene oxides. Typically these are polymers with alkylene oxy repeating units in the polymer backbone. Particularly suitable polyalkylene oxides include polyethylene oxides and polypropylene oxides. Generally these polymers will have a molecular weight of at least 500,000 and often at least one million. The molecular weight of the polyethers may be as high as 15 million of 20 million or higher.

Another preferred class of synthetic polymers include vinyl addition polymers. These polymers are formed from an ethylenically unsaturated water-soluble monomer or blend of monomers.

The water soluble polymer may be cationic, non-ionic, amphoteric, or anionic. The polymers may be formed from any suitable water-soluble monomers. Typically the water soluble monomers have a solubility in water of at least 5 g/100 cc at 25° C. Particularly preferred anionic polymers are formed from monomers selected from ethylenically unsaturated carboxylic acid and sulphonic acid monomers, preferably selected from (meth)acrylic acid, allyl sulphonic acid and 2-acrylamido-2-methyl propane sulphonic acid, and their salts, optionally in combination with non-ionic co-monomers, preferably selected from (meth)acrylamide, hydroxy alkyl esters of (meth)acrylic acid and N-vinyl pyrrolidone. Especially preferred polymers include consisting of homopolymers of acrylic acid or salts thereof, homopolymers of acrylamide and copolymers of acrylamide and acrylic acid or salts thereof.

Preferred non-ionic polymers are formed from ethylenically unsaturated monomers selected from (meth)acrylamide, hydroxy alkyl esters of (meth)acrylic acid and N-vinyl pyrrolidone.

Preferred cationic polymers are formed from ethylenically unsaturated monomers selected from dimethyl amino ethyl(meth)acrylate-methyl chloride, (DMAEA.MeCl) quat, diallyl dimethyl ammonium chloride (DADMAC), trimethyl amino propyl(meth)acrylamide chloride (ATPAC) optionally in combination with non-ionic co-monomers, preferably selected from (meth)acrylamide, hydroxy alkyl esters of (meth)acrylic acid and N-vinyl pyrrolidone.

In the invention, the polymer may be formed by any suitable polymerisation process. The polymers may be prepared for instance as gel polymers by solution polymerisation, water-in-oil suspension polymerisation or by water-in-oil emulsion polymerisation. When preparing gel polymers by solution polymerisation the initiators are generally introduced into the monomer solution.

Optionally a thermal initiator system may be included. Typically a thermal initiator would include any suitable initiator compound that releases radicals at an elevated temperature, for instance azo compounds, such as azo-bis-isobutyronitrile. The temperature during polymerisation should rise to at least 70° C. but preferably below 95° C. Alternatively polymerisation may be effected by irradiation (ultra violet light, microwave energy, heat etc.) optionally also using suitable radiation initiators. Once the polymerisation is complete and the polymer gel has been allowed to cool sufficiently the gel can be processed in a standard way by first comminuting the gel into smaller pieces, drying to the substantially dehydrated polymer followed by grinding to a powder.

Such polymer gels may be prepared by suitable polymerisation techniques as described above, for instance by irradiation. The gels may be chopped to an appropriate size as required and then on application mixed with the material as partially hydrated water soluble polymer particles.

The polymers may be produced as beads by suspension polymerisation or as a water-in-oil emulsion or dispersion by water-in-oil emulsion polymerisation, for example according to a process defined by EP-A-150933, EP-A-102760 or EP-A-126528.

Alternatively the water soluble polymer may be provided as a dispersion in an aqueous medium. This may for instance be a dispersion of polymer particles of at least 20 microns in an aqueous medium containing an equilibrating agent as given in EP-A-170394. This may for example also include aqueous dispersions of polymer particles prepared by the polymerisation of aqueous monomers in the presence of an aqueous medium containing dissolved low IV polymers such as poly diallyl dimethyl ammonium chloride and optionally other dissolved materials for instance electrolyte and/or multi-hydroxy compounds e. g. polyalkylene glycols, as given in WO-A9831749 or WO-A-9831748.

The aqueous solution of water-soluble polymer is typically obtained by dissolving the polymer in water or by diluting a more concentrated solution of the polymer. Generally solid particulate polymer, for instance in the form of powder or beads, is dispersed in water and allowed to dissolve with agitation. This may be achieved using conventional make up equipment. Desirably, the polymer solution can be prepared using the Auto Jet Wet (trademark) supplied by BASF.

Alternatively, the polymer may be supplied in the form of a reverse phase emulsion or dispersion which can then be inverted into water.

The following examples illustrate the invention.

### EXAMPLE 1

### Influence of Ultrasonic Energy on Flocculated Materials Based on Yield Stress Determination of Sedimented Materials

900 mL of around 40% w/v china clay at pH 12 (pH regulated by addition of calcium hydroxide) was placed in a 1 L beaker fit with a Heidolph stirrer system equipped with a marine impellor. Under aggitation at 370 rpm, 200 g/ton of a polymer consisted of acrylamide/sodium-2-acrylamido-2-methylpropane sulfonic acid 70/730 copolymer was added as a powder (100%) into the slurry vortex and mixed at constant speed for 2 minutes. Then the agitation was stopped and the flocculated slurry was subsampled into three different samples by transferring the material into glass bottles of around 250 mL each.

The slurry from those samples was mixed again at 450 rpm speed and ultrasonic irradiation was applied for 30 seconds at an amplitude of 10% (1.3 μm) and 100% (13 μm). After that the sample was straightforward subjected to yield stress measurements (using a Brookfield Soft Solids Tester fitted with a vane).

The ultrasonic generator used was a Bandelin, model HD 3200 (20 kHz frequency, 25-200 W power) coupled with a Sonotrode: model VS 70T.

Therefore the specific energy was estimated as 3 W·sec/mL at 10% (1.3 μm) amplitude and 24 W·sec/mL at 100% (13 μm) amplitude.

Control tests were performed with the procedure described above without the ultrasonic irradiation (named as Reference).

Other tests were performed with ultrasonic irradiation for 30 seconds at an amplitude of 10% of the total range which corresponds to 1.3 μm concomitantly with the addition of both hydrogen peroxide (100 ppm) and copper (II) ions (10% w/v solution of copper sulphate at pH 2 regulated by addition of sulphuric acid) (100 ppm) and without ultrasonic irradiation but with the addition of oxidising agents only, such as hydrogen peroxide (100 ppm) and copper (II) ions (10% w/v solution of copper sulphate at pH 2 regulated by addition of sulphuric acid) (100 ppm), as presented in table 1.

The results of the three yield stress measured per test were averaged and a relative decrease in rheology (RDR) was determined by:

RDR (%)=100−{[YS (Pa)×100]/YSRef}

Where,

RDR relative decrease in rheology

YS yield stress

YSRef yield stress of the sample without the application of irradiation and/or active system (reference)

TABLE 1

| Ultrasonic | Ultrasonic | Hydrogen | Copper | | Yield | |
|---|---|---|---|---|---|---|
| Irradiation | Irradiation | Peroxide | Sulphate | | Stress (Pa) | |
| Amplitude | Time | Dose | Dose | Description | Average | DRD |
| — | — | — | — | Reference | 350.12 | 100% |
| 10% (1.3 μm) | 30 sec | — | — | US(10%) 30 s | 347.13 | 0.85% |
| 100% (13 μm) | 30 sec | — | — | US(100%) 30 s | 309.20 | 11.70% |
| — | — | 100 ppm | — | 100 ppm H2O2 | 340.58 | 2.72% |
| | | | 100 ppm | 100 ppm Cu(II) | 320.05 | 8.58% |
| 10% | 30 sec | 100 ppm | 100 ppm | US(10%)30 s | 287.48 | 17.90% |
| | | | | 100 ppm H2O2 | | |
| | | | | 100 ppm Cu(II) | | |

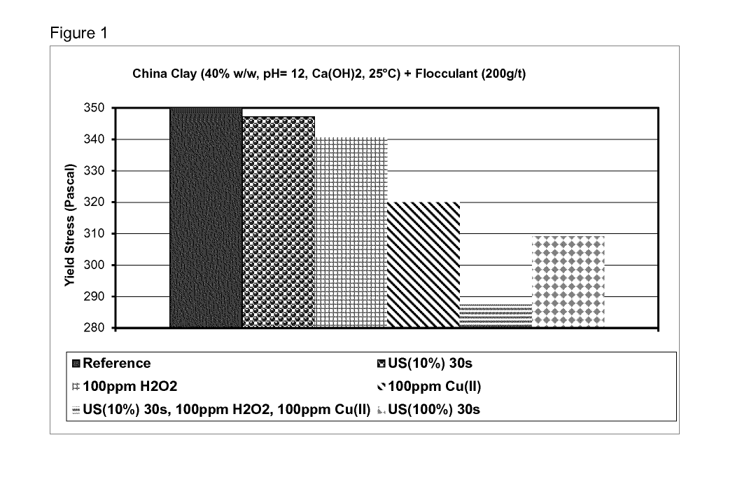

FIG. 1 shows the effect of the ultrasonic irradiation on the yield stress (rheology) of the flocculated material. A slight decrease is obtained when an amplitude of 10% (1.3 μm) is applied for 30 seconds, however, at 100% (13 μm) amplitude the decrease in yield stress is considerable (around 12% relative decrease). This change in rheological property of the treated material may be interpreted as result of the combination of the hydrodynamic shear force (mechanical effect) and in situ formation of free radicals and hydrogen peroxide (chemical effect) applied and provided by the ultrasonic irradiation, which distress the system breaking down part of the big flocs presented in the sedimented material into small aggregates, decreasing thus the associated yield stress.

When in combination with two oxidizing system (hydrogen peroxide and hydrogen peroxide plus copper (II) ions), the results show once more that the degree of reduction of yield stress enhances. The results show that the application of the called Sono-Fenton system (ultrasonic irradiation plus hydrogen peroxide and copper (II) ions) gives rise to the greatest reduction in yield stress (around 18% relative decrease). The hydrogen peroxide is considered to assist the early formation of free radicals (eg. hydroxyl peroxide (.OH)) which are promoted by the ultrasonic irradiation (named Sonolysis or cavitation phenomena), while the copper (II) ion is considered to promote the formation of free radicals (eg. hydroxyl peroxide (.OH)) from the hydrogen peroxide added or formed as a resultant of the (homo-)quenching reaction between hydroxyl peroxide radicals (named Fenton system).

1. A process of concentrating an aqueous suspension of solid particles, comprising:
introducing the aqueous suspension of solid particles into a vessel,
adding at least one organic polymeric flocculant to the aqueous suspension of solid particles thereby forming flocculated solids,
allowing the flocculated solids to settle to form a compression zone, comprising a bed of sedimented solids in suspension at the lower end of the vessel,
flowing the sedimented solids from the vessel as an underflow stream,
in which an effective amount of ultrasonic energy is applied to:
a) the bed of solids at the compression zone;
b) the sedimented solids in the underflow stream; or
c) a recycle stream containing sedimented solids taken from either the underflow stream or the compression zone which are then recycled back to the vessel in which a chemical agent is applied to the aqueous suspension of solid particles,
wherein the chemical agent is selected from the group consisting of at least one of an oxidising agent, free radical agent and reducing agent.

2. The process according to claim 1, in which the ultrasonic energy applied to the bed of solids or the underflow will be in the range of 0.1 to 1000 Watts seconds/millilitres specific energy.

3. The process according to claim 1, in which the ultrasonic energy is applied at a frequency in the range of 1 KHz to 10 MHz.

4. The process according to claim 1 in which the ultrasonic energy is applied only to the bed of solids, to the underflow or a stream taken from the bed of solids all the underflow and recycled back to the vessel.

5. The process according to claim 1, wherein the ultrasonic energy is applied by fixing ultrasonic transducers around the inside or outside of a sidewall of the vessel or to rakes at the height of the bed of solids, the transducers being connected to a control unit which can adjust the power output of the transducer to a desired power density.

6. The process according to claim 1 in which the ultrasonic energy is applied to the bed of solids from a rake.

7. (canceled)

8. The process according to claim 1 in which the chemical agent is applied to the bed of solids, the underflow or a stream taken from the bed of solids or the underflow and recycled back to the vessel.

9. The process according to claim 1 in which an agent system is applied to the aqueous suspension of solid particles, wherein the agent system comprises i) at least one oxidising agent as the at least one active agent; and ii) at least one control agent,
wherein the at least one control agent consists of iia) at least one activator component and/or iib) at least one suppressor component, in which the at least one activator component increases the activity of the oxidising agent and the suppressor component decreases the concentration or the activity of the activator component.

10. The process according to claim 1 in which the vessel is a gravimetric thickener.

11. The process according to claim 1 in which the aqueous suspension of solid particles comprises mineral particles.

12. The process according to claim 1 in which the aqueous suspension of particles comprises red mud or tailings from metal extraction, acid leaching, coal, oil sands, mineral sands or other mining or mineral processing operations.

13. The process according to claim 1 in which the organic polymeric flocculant is a non-ionic or anionic polymer that is either a synthetic polymer of intrinsic viscosity of at least 4 dl/g or a natural polymer.

14. The process according to claim 1 in which the organic polymeric flocculant is selected from the group consisting of at least one homopolymer of acrylic acid or salts thereof, homopolymer of acrylamide and copolymer of acrylamide and acrylic acid or salts thereof.

15. An apparatus suitable for concentrating an aqueous suspension of solid particles comprising:
a vessel,
a means for introducing the aqueous suspension of solid particles into the vessel,
a means for introducing at least one organic polymeric flocculant to the aqueous suspension of solid particles, sufficient to form flocculated solids,
a means for allowing the flocculated solids to form compression zone comprising a bed of sedimented solids in the suspension at the lower end of the vessel,
a means for flowing the sedimented solids from the vessel as an underflow stream, in which the apparatus comprises a means for applying ultrasonic energy to:
a) the bed of solids at the compression zone;
b) the sedimented solids in the underflow stream; or a recycle stream containing sedimented solids taken from either the underflow stream or the compression zone which are then recycled back to the vessel and in which the apparatus comprises a means for applying a chemical agent to the aqueous suspension of solid particles, wherein the chemical agent is selected from the group consisting of at least one oxidising agent, flee radical agent and reducing agent.
